(19) United States
(12) Patent Application Publication
(10) Pub. No.: US 2014/0269746 A1
(43) Pub. Date: Sep. 18, 2014

(54) LOAD BALANCING OF LOGICAL CONNECTIONS OVER MULTI-CHASSIS TRUNK

(71) Applicant: BROCADE COMMUNICATIONS SYSTEMS, INC., San Jose, CA (US)

(72) Inventors: Eswara S.P. Chinthalapati, San Jose, CA (US); Lok Yan Hui, Fremont, CA (US); Srinivas Tatikonda, Fremont, CA (US); Vivek Agarwal, Campbell, CA (US)

(21) Appl. No.: 14/216,292

(22) Filed: Mar. 17, 2014

Related U.S. Application Data
(60) Provisional application No. 61/798,906, filed on Mar. 15, 2013.

(51) Int. Cl. H04L 12/721; H04L 12/931; H04L 12/723

(52) U.S. Cl. CPC H04L 45/68; H04L 45/50; H04L 49/602
USPC 370/409

(57) ABSTRACT

One embodiment of the present invention provides a switch. The switch includes a link aggregation database and a packet processor. The link aggregation database stores configuration information regarding a plurality of switches participating in a multi-chassis trunk. The plurality of switches includes the switch. The packet processor constructs a packet for a remote switch. This packet is forwardable via a logical connection. The packet includes a virtual circuit label associated with a second logical connection of a second switch. The plurality of switches includes the second switch as well.

### RELATED APPLICATIONS

This application claims the benefit of U.S. Provisional Application No. 61/798,906 (Attorney Docket Number 3211.0.US.), titled “Active-Active MCT Operation with PseudoWire Load Balancing,” by inventors Eswara S. P. Chinthalapati, Lok Yan Hui, Srinivas Tatikonda, and Vivek Agarwal, filed 15 Mar. 2013, the disclosure of which is incorporated by reference herein.

The present disclosure is related to U.S. patent application Ser. No. 12/730,749, (Attorney Docket Number BRCD-3009.1.US.NP), titled “Method and System for Extending Routing Domain to Non-Routing End Stations,” by inventors Pankaj K. Jha and Mitri Halabi, filed 24 Mar. 2010; and U.S. patent application Ser. No. 13/656,438 (Attorney Docket Number BRCD-3120.1.US.NP), titled “VPLS Over Multi-Chassis Trunk,” by inventors Srinivas Tatikonda, Rahul Vir, Eswara S. P. Chinthalapati, Vivek Agarwal, and Lok Yan Hui, filed 19 Oct. 2012, the disclosures of which are incorporated by reference herein.

### BACKGROUND

1. Field

The present disclosure relates to communication network. More specifically, the present disclosure relates to efficient implementation of a virtual private network (VPN) over multi-chassis trunks.

2. Related Art

The exponential growth of the Internet has made it a popular delivery medium for multimedia applications, such as video on demand and television. Such applications have brought with them an increasing demand for bandwidth. As a result, equipment vendors race to build larger and faster switches with versatile capabilities, such as multicasting, to move more traffic efficiently. However, the size of a switch cannot grow infinitely. It is limited by physical space, power consumption, and design complexity, to name a few factors. Furthermore, switches with higher capability are usually more complex and expensive. More importantly, because an overly large and complex system often does not provide economy of scale, simply increasing the size and capability of a switch may prove economically unviable due to the increased per-port cost.

As more time-critical applications are being implemented in data communication networks, high-availability operation is becoming progressively more important as a value proposition for network architects. It is often desirable to aggregate links to multiple switches to operate as a single logical link (referred to as a multi-chassis trunk or an MCT) to facilitate load balancing among the multiple switches while providing redundancy to ensure that a device failure or link failure would not affect the data flow. The switches participating in a multi-chassis trunk are referred to as partner switches.

Currently, such multi-chassis trunks in a network have not been able to take advantage of the distributed interconnection available for a typical virtual private local area network (LAN) service (VPLS) and virtual leased line (VLL). VPLS and VLL can provide a virtual private network (VPN) between switches located in remote sites. For example, VPLS allows geographically distributed sites to share a layer-2 broadcast domain. Individual switches (can be referred to as provider edge (PE) nodes) in a local network are equipped to manage VPLS traffic but are constrained while operating in conjunction with each other for providing a multi-chassis trunk. A PE node participating in a multi-chassis trunk can be referred to as a partner PE node. An end device coupled to a multi-chassis trunk typically sends traffic to multiple switches. A respective recipient switch then sends the traffic to a remote site using VPLS. As a result, the switches in the remote site receive traffic from the same end device via multiple switches and observe continuous end device movement. Such movement hinders the performance of VPLS.

While multi-chassis trunk brings many desirable features to networks, some issues remain unsolved for VPLS implementations.

### SUMMARY

One embodiment of the present invention provides a switch. The switch includes a link aggregation database and a logical connection module. The link aggregation database stores configuration information regarding a plurality of switches participating in a multi-chassis trunk. The plurality of switches includes the switch. The packet processor constructs a packet for a remote switch. This packet is forwardable via a logical connection. The packet includes a virtual circuit label associated with a second logical connection of a second switch. The plurality of switches includes the second switch as well.

In a variation on this embodiment a respective logical connection is a pseudo-wire associated with a virtual private local area network (LAN) service (VPLS) instance, wherein the pseudo-wire represents a logical link in a virtual private network (VPN).

In a variation on this embodiment, the pseudo-wire is based on one or more of: (1) Internet Protocol (IP), and (2) Multiprotocol Label Switching (MPLS) connection.

In a variation on this embodiment, the switch is a standby switch and the second switch is an active switch of the multi-chassis trunk.

In a variation on this embodiment, the logical connection module extracts the virtual circuit label from the payload of a notification message.

In a variation on this embodiment, the switch also includes a trunk module which selects the switch as an active switch in response to an unavailability of the second switch.

In a variation on this embodiment, the logical connection module also constructs a packet for a second remote switch. This packet is forwardable via a second logical connection between the switch and the second remote switch. The remote switch and the second remote switch participate in a second multi-chassis trunk.

In a further variation, the second logical connection is a virtual leased line (VLL).

### BRIEF DESCRIPTION OF THE FIGURES

FIG. 1A illustrates an exemplary virtual private network comprising a multi-chassis trunk with active-active load balancing, in accordance with an embodiment of the present invention.

FIG. 1B illustrates an exemplary simulated active-active logical connection in a virtual private network with a multi-chassis trunk, in accordance with an embodiment of the present invention.

FIG. 1C illustrates exemplary labels for simulated active-active logical connection in a virtual private network with a multi-chassis trunk, in accordance with an embodiment of the present invention.

FIG. 2 illustrates an exemplary distributed simulated active-active logical connection in a virtual private network with a multi-chassis trunk, in accordance with an embodiment of the present invention.

FIG. 3 presents a flowchart illustrating the process of a PE node in a multi-chassis trunk establishing logical connections, in accordance with an embodiment of the present invention.

FIG. 4A presents a flowchart illustrating the process of a PE node in a multi-chassis trunk forwarding a unicast data packet, in accordance with an embodiment of the present invention.

FIG. 4B presents a flowchart illustrating the process of a PE node in a multi-chassis trunk forwarding a multi-destination packet, in accordance with an embodiment of the present invention.

FIG. 5 illustrates exemplary unavailability in a virtual private network with a multi-chassis trunk, in accordance with an embodiment of the present invention.

FIG. 6A presents a flowchart illustrating the process of a PE node in a multi-chassis trunk recovering from a partner node's unavailability, in accordance with an embodiment of the present invention.

FIG. 6B presents a flowchart illustrating the process of a PE node in a multi-chassis trunk recovering from a link failure, in accordance with an embodiment of the present invention.

FIG. 7 illustrates an exemplary architecture of a switch operating as a PE node, in accordance with an embodiment of the present invention.

In the figures, like reference numerals refer to the same figure elements.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

### Overview

In embodiments of the present invention, the problem of facilitating load balancing in a virtual private network (VPN) with a multi-chassis trunk is solved by allowing a respective partner provider edge (PE) node of the multi-chassis trunk to use a virtual circuit (VC) label of a logical connection of an active PE node of the multi-chassis trunk. A multi-chassis trunk is established when an end device is coupled to a plurality of networking devices (e.g., switches) using a link aggregation. The end device coupled to a multi-chassis trunk can be referred to as a multi-homed end device. The aggregated links operate as a single logical link to facilitate load balancing among the multiple switches while providing redundancy. The switches participating in a multi-chassis trunk (referred to as partner switches) synchronize their configuration information with each other. Based on the synchronized information, partner switches are configured to appear as a single logical switch to the end device.

However, partner switches typically operate as two separate switches in a VPN for a VPLS instance. Network devices (e.g., switches and routers) that are capable of originate and terminate connection for a VPLS instance can be referred to as provider edge (PE) nodes. A PE node typically sends traffic to another PE node in a remote network site. The PE node in the remote network site can be referred to as a remote PE node. To exchange traffic, a PE node creates a logical connection with a remote PE node in the VPN. This logical connection can be identified based on a VC label associated with the logical connection. In some embodiments, a logical connection is a VPLS pseudo-wire created using Multiprotocol Label Switching (MPLS) or Internet Protocol (IP) connections. The PE node encapsulates a packet based on the logical connection (e.g., an IP encapsulation for an IP-based logical connection) and forwards the packet to the remote PE node.

End devices coupled to PE nodes can be referred to as customer edge (CE) nodes. Note that the same physical networking device can operate as a regular switch and a PE node. The networking device can operate as a switch while communicating with a CE node and as a PE node while communicating with another PE node. Hence, a partner switch of a multi-chassis trunk capable of originating and terminating connections for a VPLS instance can be considered as PE nodes as well. Such partner switches operate as a single logical switch for a multi-homed CE node while operating as two separate PE nodes for a respective VPLS instance. Partner switches operating as PE nodes and participating in a multi-chassis trunk can be referred to as partner PE nodes.

A multi-homed CE node forwards traffic to a respective partner PE node based on a distribution policy. An example of a distribution policy includes, but is not limited to, address hashing, wherein a hash function is applied to an egress layer-2/layer-3 address to determine to which partner PE node the CE node forwards. As a result, a respective partner PE node receives traffic from the CE node and, in turn, forwards that traffic to a remote PE node. The remote PE node receives traffic coming from the same CE node via two different PE nodes. When the remote PE node independently receives such traffic from multiple PE nodes, the remote PE node considers that the CE node is moving between the PE nodes. In other words, the remote PE node perceives that the CE node is continuously decoupling from one partner PE node and coupling to another partner PE node.

The remote PE node thus continuously updates the local layer-2 forwarding table. Such movement hinders self-learning-based layer-2 switching (e.g., Ethernet switching) in a virtual private network. To avoid this, one of the partner PE nodes can operate as an active PE node, which is responsible for forwarding traffic to the remote PE node. Other standby PE nodes forward their traffic from the multi-homed CE node to this active PE node using a logical connection (which can be referred to as a spoke). However, this causes the active PE node and its links to be heavily utilized, and the standby partner PE nodes to remain underutilized.

To solve this problem, in the embodiments of the present invention, a respective partner PE node of a multi-chassis trunk uses the VC label of the logical connection of the active PE node to forward traffic to a remote PE node via the corresponding logical connection. When the remote PE node learns the layer-2 address (e.g., a media access control (MAC) address) of a CE node from a logical connection, the remote PE node associates the learned address with the VC label of a logical connection. In other words, based on the VC label, the remote PE node determines to which PE node the CE node is coupled. Even when the remote PE node receives packets from different logical connections, if the same VC label used in the packets for forwarding via the logical connections (e.g., the same VC label is used in the encapsulation header of the packet), the remote PE node considers the CE node to be coupled to the same PE node.

If a multi-homed CE node sends packets to different partner PE nodes it is coupled to, the recipient partner PE node can use the VC label of the logical connection between the remote PE node and the active PE node for forwarding the packet via its own logical connection with the remote PE node. As a result, even though the remote PE node receives the packets via different logical connections, the remote PE node considers that the packets are from the active PE node and the CE node is coupled with the active PE node. In this way, traffic from a multi-homed CE node is balanced across the partner PE nodes and their corresponding logical connection without causing the remote PE node to perceive a movement of a CE node.

In some embodiments, the partner PE nodes are member switches of a fabric switch. An end device can be coupled to the fabric switch via a multi-chassis trunk. A fabric switch in the network can be an Ethernet fabric switch or a virtual cluster switch (VCS). In an Ethernet fabric switch, any number of switches coupled in an arbitrary topology may logically operate as a single switch. Any new switch may join or leave the fabric switch in “plug-and-play” mode without any manual configuration. In some embodiments, a respective switch in the Ethernet fabric switch is a Transparent Interconnection of Lots of Links (TRILL) routing bridge (RBridge). A fabric switch appears as a single logical switch to the end device.

Although the present disclosure is presented using examples based on VPLS, embodiments of the present invention are not limited to VPLS. Embodiments of the present invention are relevant to any method that facilitate a virtual private network. In this disclosure, the term “VPLS” is used in a generic sense, and can refer to any network interconnection virtualization technique implemented in any networking layer, sub-layer, or a combination of networking layers.

In this disclosure, the term “PE node” is used in a generic sense and can refer to any network device participating in a virtual private network. A PE node can refer to any networking device capable of establishing and maintaining a logical connection to another remote networking device. The term “logical connection” can refer to a virtual link which spans one or more physical links and appears as a single logical link between the end points of the logical connection. Examples of a logical connection include, but are not limited to, a VPLS pseudo-wire, and an MPLS or Generalized MPLS (GMPLS) connection.

In this disclosure, the term “end device” can refer to a host machine, a conventional switch, or any other type of networking device. An end device can be coupled to other switches or hosts further away from a network. An end device can also be an aggregation point for a number of switches to enter the network. The term “CE node” can refer to a host machine, a conventional switch, or any other type of networking device coupled to a PE node via one or more physical links. The terms “end device” and “CE node” are interchangeably in this disclosure.

The term “packet” refers to a group of bits that can be transported together across a network. “Packet” should not be interpreted as limiting embodiments of the present invention to any networking layer. “Packet” can be replaced by other terminologies referring to a group of bits, such as “message,” “frame,” “cell,” or “datagram.”

The term “switch” is used in a generic sense, and it can refer to any standalone or fabric switch operating in any network layer. “Switch” should not be interpreted as limiting embodiments of the present invention to layer-2 networks. Any physical or virtual device (e.g., a virtual machine, which can be a virtual switch, operating on a computing device) that can forward traffic to an end device can be referred to as a “switch.” Examples of a “network device” include, but not limited to, a layer-2 switch, a layer-3 router, or a TRILL RBridge. In this disclosure, the terms “switch” and “PE node” are used interchangeably. The same physical device can be referred to as a switch and a PE node.

The term “fabric switch” refers to a number of interconnected physical switches which form a single, scalable logical switch. In a fabric switch, any number of switches can be connected in an arbitrary topology and the entire group of switches functions together as one single switch. This feature makes it possible to use many smaller, inexpensive switches to construct a large fabric switch, which can be viewed externally as a single switch.

### Network Architecture

FIG. 1A illustrates an exemplary virtual private network comprising a multi-chassis trunk with active-active load balancing, in accordance with an embodiment of the present invention. As illustrated in FIG. 1A, a virtual private network (VPN) 100 includes network sites 110, 120, and 130, interconnected via network 140. In some embodiments, network 140 is an MPLS network. Site 110 includes PE nodes 112 and 114. Multi-homed CE node 113 is coupled to partner PE nodes 112 and 114 via multi-chassis trunk 117. Because multi-chassis trunk 117 logically aggregates the links between CE node 113, and PE nodes 112 and 114, multi-chassis trunk 117 can be referred to as a virtual link aggregation as well. PE nodes 112 and 114 can be coupled to each other via one or more physical links. CE nodes 111 and 115 are coupled to PE nodes 112 and 114, respectively, via one or more physical links. In this example, CE node 115 can be a layer-2 switch. Site 120 includes CE node 121 coupled to PE nodes 122 and 124 via one or more physical links. Site 130 includes CE node 131 coupled to PE node 132 via one or more physical links. In some embodiments, partner PE nodes 112 and 114 have a separate identifier (e.g., an Internet Protocol (IP) address), respectively. These identifiers individually identify partner PE nodes 112 and 114 in network 140.

During operation, PE nodes 112 and 114 recognize each other as partner PE nodes. A PE node can recognize a partner PE node from local information preconfigured by a network administrator. PE nodes 112 and 114 establish a point-to-point connection among them and synchronize configuration information. Configuration information can include, but are not limited to, a PE node identifier (e.g., an IP address), a virtual circuit label or a VC label, a virtual circuit mode, and the layer-2 forwarding table size. PE nodes 112 and 114 can store the configuration information in a local link-aggregation database (e.g., a table). In some embodiments, PE nodes 112 and 114 exchange notification messages to synchronize the configuration information. The payload of a notification message include the configuration information, such as a VC label.

In some embodiments, PE node 112 constructs a control message requesting to establish a separate logical connection and sends the control message to partner PE node 114. In the same way, PE node 114 also creates a control message and sends the control message to partner PE node 112. By exchanging these control messages, PE nodes 112 and 114 create a separate network 142 and interconnect each other via logical connection 150. Logical connection 150 can be an MPLS-based VPLS pseudo-wire. A logical connection between two partner PE nodes, such as logical connection 150, can be referred to as a spoke.

In some embodiments, partner PE nodes 112 and 114 select an active PE node. Suppose that PE node 112 is selected as the active node and PE node 114 as a standby node. PE nodes 112 and 114 can exchange control messages via spoke 150 to select the active node. PE nodes 112 and 114 can use a distributed protocol to select the active node. In some embodiments, PE nodes 112 and 114 exchange their respective identifiers with each other and select the PE node with the lowest (or the highest) identifier value as the active node. Note that both partner PE nodes 112 and 114 can identify the active PE node from the locally stored information (e.g., PE node identifier). For example, PE node 114 can select and recognize PE node 112 as the active PE node based on the locally stored information regarding PE node 112.

Note that network 142 is a separate network than network 140. Network 142 is established after PE nodes 112 and 114 exchange information to recognize each other as partner PE nodes. In some embodiments, PE nodes 112 and 114 use point-to-point Cluster Communication Protocol (CCP) to exchange information. Spoke 150 allows PE nodes 112 and 114 to send control messages for signaling each other even without any activity of a local CE node. For example, PE node 112 can send a control message to PE node 114 even when CE nodes 111 and 113 are inactive. Messages sent via spoke 150 can have a different forwarding strategy than the other logical connections in network 140. To avoid any conflict in layer-2 address self-learning, in some embodiments, PE nodes 112 and 114 do not learn layer-2 addresses from the packets received via spoke 150.

In some embodiments, PE nodes 112 and 114 operate as layer-2 switches while communicating with CE nodes 111, 113, and 115. CE node 113 exchanges traffic with both partner PE nodes 112 and 114 for communicating with other networking devices, such as CE node 131. In some embodiments, CE node 113 selects PE node 112 or 114 for sending a packet based on a distribution policy (e.g., address hashing). If both PE nodes 112 and 114 forward that traffic to remote PE node 132, that traffic from CE node 113 is received by PE node 132 via two different PE nodes 112 and 114. PE node 132 then determines that CE node 132 is moving between PE nodes 112 and 114.

To solve this problem, when standby PE node 114 receives a packet for PE node 132, PE node 114 forwards that packet to PE node 132 using the VC label of the logical connection between PE nodes 112 and 132. As a result, even though PE node 132 receives the packet from PE node 114, PE node 132 determines that the packet has been received from PE node 112. Hence, multi-homed CE node 113 can actively forward packet to PE node 132 via both PE nodes 112 and 114. In this way, embodiments of the present invention implement multi-chassis trunk 117 with VPLS support. Note that the VPLS instance(s) in PE nodes 112 and 114 is aware of multi-chassis trunk 117. As a result, PE nodes 112 and 114 can distinguish multi-homed CE node 113 from other local CE nodes 111 and 115.

In network site 120, CE node 121 is coupled to PE nodes 122 and 124. However, without a multi-chassis trunk between CE node 121, and PE nodes 122 and 124, CE node 121 blocks traffic exchange with PE node 124 to break the loop and exchanges traffic only with PE node 122. PE nodes 122 and 124 can also operate in a master-slave mode. PE node 122 can be the master node and actively communicate with CE node 121. PE node 124 can be the slave node and only operates when PE node 122 becomes non-operational. To improve the performance, a multi-chassis trunk 123 can be established by logically aggregating the links between CE node 121 and PE nodes 122 and 124. After multi-chassis trunk 123 is established, CE node 121 exchanges traffic with both PE nodes 122 and 124. PE nodes 122 and 124 can select PE node 122 as an active node. PE node 124 then becomes a standby node. Operation of multi-chassis trunk 123 can be similar to multi-chassis trunk 117, wherein PE node 124 uses the VC label of the logical connection between PE nodes 122 and 112 to forward a packet to PE node 112 via its logical connection.

Since both PE nodes 112 and 114 forward traffic to remote PE node 122 using the VC label of the logical connection between PE nodes 112 and 122, PE node 122 considers CE node 113 to be coupled with PE node 112. Remote PE node 122 forwards traffic for CE node 113 only to PE node 112. In some embodiments, PE node 114 creates a control message informing the remote PE nodes regarding the standby status of PE node 114. Because of the standby status, the remote PE nodes determines that PE node 114 does not actively forward traffic to remote PE nodes and provides redundancy to active PE node 112.

### Logical Connections

FIG. 1B illustrates an exemplary simulated active-active logical connection in a virtual private network with a multi-chassis trunk, in accordance with an embodiment of the present invention. During operation, PE node 112 establishes logical connections 152, 162, and 154 with remote PE nodes 122, 124, and 132, respectively. Similarly, PE node 114 establishes logical connections 164, 172, and 166 with remote PE nodes 122, 124, and 132, respectively. When partner PE nodes 112 and 114 select PE node 112 as the active node, PE node 112 sends a control message indicating the active status of PE node 112 to remote PE node 122. On the other hand, PE node 114 sends a control message indicating the standby status of PE node 114 to remote PE node 122.

In some embodiments, the control message is a type-length-value (TLV) message. A respective PE node can construct the TLV message based on pseudo-wire redundancy as described in Internet Engineering Task Force (IETF) draft “Pseudowire (PW) Redundancy,” available at http://tools.ietf.org/html/draft-ietf-pwe3-redundancy-03, which is incorporated by reference herein. PE node 122 also sends a control message indicating the active status of PE node 122 to its remote PE node 112. Similarly, PE node 124 sends a control message indicating the standby status of PE node 124 to its remote PE node 112. As a result, both end points of logical connection 152 are active (can be referred to as an active-active logical connection). However, one end point of logical connection 162 is active while the other end point is standby (can be referred to as an active-standby logical connection). On the other hand, both end points of logical connection 172 are standby (can be referred to as a standby-standby logical connection).

In some embodiments, a respective logical connection can be identified by a virtual circuit label. The partner PE nodes participating in a multi-chassis trunk can use the same virtual circuit label for forwarding traffic via a VPLS instance. For example, logical connections 152 and 164 can use the same virtual circuit label for forwarding traffic via a VPLS instance. Partner PE nodes 112 and 114 are configured with identical configuration, such as virtual circuit mode and layer-2 forwarding table size. Furthermore, partner PE nodes 112 and 114 are configured with identical set of remote PE nodes. For example, PE nodes 112 and 114 both have PE nodes 122, 124, and 132 as remote PE nodes. PE nodes 112 and 114 establish logical connections 152, 162, 164, and 172 to form a full mesh connectivity with remote site 120. Similarly, PE nodes 112 and 114 also establish logical connections 154 and 155 to form a full mesh connectivity with remote site 130.

PE nodes 122 and 124 recognize logical connection 152 to be active-active, logical connections 162 and 164 to be active-standby, and logical connection 172 to be standby-standby logical connections. However, because PE nodes 114 uses the VC label of logical connection 152 to communicate with PE node 122, PE node 114 can simulate the operations of an active-active logical connection and forward traffic via logical connection 164. Hence, partner PE nodes 112 and 114 consider logical connection 164 as a simulated active-active logical connection. On the other hand, when PE node 122 receives a packet from CE node 113 via logical connection 164, PE node 122 identifies the VC label of logical connection 152 in the packet and considers that the packet has been received from PE node 112 via logical connection 152.

In site 130, PE node 132 may not implement pseudo-wire redundancy. As a result, when PE nodes 112 and 114 send control messages indicating their respective status, PE node 132 does not recognize the messages and considers all remote PE nodes as active. Furthermore, PE node 132 keeps all logical connections active and does not send any status-indicating control message to its remote PE nodes. Because PE nodes 112 and 114 do not receive any status-indicating control message from PE node 132, PE nodes 112 and 114 considers PE node 132 as active. However, even though PE node 114 is the standby node, PE nodes 114 uses the VC label of logical connection 154 to communicate with PE node 132, thereby simulating the operations of an active-active logical connection and forward traffic via logical connection 166. Hence, partner PE nodes 112 and 114 consider logical connection 166 as a simulated active-active logical connection as well. On the other hand, when PE node 132 receives a packet from CE node 113 via logical connection 166, PE node 132 identifies the VC label of logical connection 152 in the packet and considers that the packet has been received from PE node 112 via logical connection 152.

FIG. 1C illustrates exemplary labels for simulated active-active logical connection in a virtual private network with a multi-chassis trunk, in accordance with an embodiment of the present invention. During operation, partner PE nodes 112 and 114 exchange configuration information. As a result, PE nodes 112 and 114 become aware of each other's logical connections and corresponding virtual circuit labels. For example, active PE node 112 determines that remote active PE node 122 is reachable via logical connection 152 using VC label 182. PE node 112 also determines that PE node is reachable via logical connection 184 of standby partner PE node 114 using VC label 184. Furthermore, PE node 112 determines that partner PE node 114 is reachable via spoke 150 (from PE node 112 to PE node 114) using spoke VC label 186.

Similarly, standby PE node 114 determines that remote active PE node 122 is reachable via logical connection 152 of partner PE node 112 using VC label 182. PE node 114 also determines PE node 122 is reachable via local logical connection 164 using local VC label 184. Furthermore, PE node 114 determines that partner PE node 112 is reachable via spoke 150 (from PE node 114 to PE node 112) using spoke VC label 188. Standby PE node 114 of multi-chassis trunk 117 thus determines that PE 122 can be reached using VC label 182 of active-active logical connection 152. This allows PE node 114 to associate VC label 182 with its logical connection 164 and use VC label 182 to forward traffic to PE node 122 via logical connection 164. It should be noted that VC labels can be directional. For example, the VC label of PE node 112 for spoke 150 from PE node 112 to PE node 114 is different than the VC label of PE node 114 for spoke 150 from PE node 114 to PE node 112. Similarly, the VC label of PE node 112 for logical connection 152 from PE node 112 to PE node 122 is different than the VC label of PE node 122 for logical connection 152 from PE node 122 to PE node 112.

FIG. 2 illustrates an exemplary distributed simulated active-active logical connection in a virtual private network with a multi-chassis trunk, in accordance with an embodiment of the present invention. In the example in FIG. 2, partner PE nodes 112 and 114 operate as the active and standby PE nodes, respectively, for multi-chassis trunk 117. Similarly, partner PE nodes 122 and 124 operate as the active and standby PE nodes, respectively, for multi-chassis trunk 123. By using the VC label of logical connection 152 of PE node 112, PE node 114 can actively forward traffic of CE node 113 to PE node 122. As a result, traffic from CE node 113 is received by PE node 122 via both PE nodes 112 and 114. Similarly, by using the VC label of logical connection 152 of PE node 122, which is different than the VC label of logical connection 152 of PE node 112, PE node 124 can actively forward traffic of CE node 121 to PE node 112. As a result, traffic from CE node 121 is received by PE node 112 via both PE nodes 122 and 124.

To further distribute traffic across the remote PE nodes, in some embodiments, PE nodes 114 and 124 operate logical connection 172 as a simulated active-active logical connection. To do so, PE nodes 112, 114, 122, and 124 can be configured to send traffic to a standby remote PE node. PE node 114 uses the VC label of logical connection 152 of PE node 112 to forward traffic via logical connection 172 to PE node 124. Similarly, PE node 124 uses the VC label of logical connection 152 of PE node 122 to forward traffic via logical connection 172 to PE node 114. This allows PE nodes 112 and 114 to actively forward to PE nodes 122 and 124, respectively, and distribute traffic from CE nodes 113 across remote PE nodes 122 and 124. Similarly, this allows PE nodes 122 and 124 to actively forward to PE nodes 112 and 114, respectively, and distribute traffic from CE nodes 121 across remote PE nodes 112 and 114. In this example, logical connections 152 and 172 can be point-to-point logical connections, such as VLLs.

FIG. 3 presents a flowchart illustrating the process of a PE node in a multi-chassis trunk establishing logical connections, in accordance with an embodiment of the present invention. During operation, the PE node establishes a point-to-point connection with a partner PE node (operation 302). The PE node can recognize a partner PE node from local information preconfigured by a network administrator. In some embodiments, the PE node uses CCP to exchange information with the partner PE node. The PE node establishes a spoke (i.e., a logical connection) with the partner PE node(s) for a respective VPLS instance (operation 304). For example, if the PE node is operating two VPLS instances corresponding to two VPLS sessions, the PE node establishes two spokes with a respective the partner PE node, wherein a respective spoke is associated with a respective VPLS instance. In some embodiments, the logical connections are MPLS-based VPLS pseudo-wires. The same spoke can be used to support a plurality of multi-homed CE nodes coupled to the same partner PE nodes.

The PE node then establishes logical connections with remote PE nodes based on the corresponding virtual circuit labels (operation 306). It should be noted that a spoke is created for a VPLS instance separate from other VPLS instances. The PE node selects an active PE node among the partner PE nodes in conjunction with each other for a respective multi-chassis trunk and for a respective VPLS instance (operation 308). The partner PE nodes can exchange control messages via the spoke to select the active PE node. The partner PE nodes can use a distributed protocol to select the active PE node. In some embodiments, the partner PE nodes exchange their respective identifiers with each other and select the PE node with the lowest (or the highest) identifier value as the active PE node.

The PE node synchronizes configuration information with partner PE node(s) (operation 310). Such configuration information can include, but are not limited to, PE node identifier (e.g., an IP address), virtual circuit label, virtual circuit mode, and the layer-2 forwarding table size. The PE node then checks whether the local PE node has been elected as the active PE node (operation 312). If the local PE node has been elected an active PE node, the PE node constructs a message indicating the active status of the PE node and sends the message to its remote PE nodes via the established logical connections (operation 314). Sending the message can include identifying an egress port for the message and transmitting the message via the identified egress port. In some embodiments, the message is constructed based on VPLS pseudo-wire redundancy. If the local PE node has not been elected as the active PE node (i.e., has been elected as a standby PE node), the PE node constructs a message indicating the standby status of the PE node and sends the message to its remote PE nodes via the established logical connections (operation 316). The PE node also identifies the VC label of the active partner PE node from the synchronized information and associates the VS label with the local logical connection to the remote active PE node (operation 318), as described in conjunction with FIG. 1C.

### Forwarding Process

A PE node participating in a multi-chassis trunk forwards a packet based on the type of the packet (e.g., unicast, multicast, or broadcast) and how the packet has been received by the PE node (e.g., from a local port, spoke, or logical connection). It should be noted that a local edge port can be a port coupling a regular CE node. FIG. 4A presents a flowchart illustrating the process of a PE node in a multi-chassis trunk forwarding a unicast data packet, in accordance with an embodiment of the present invention. During operation, the PE node receives a unicast packet for a remote PE node (operation 402). For example, PE node 112 or 114 in FIG. 1B can receive a unicast packet for remote PE node 122. The PE node then checks whether the local PE node is the active PE node (operation 404).

If the local PE node is not the active PE node, the PE node checks whether the PE node has received the packet via the multi-chassis trunk (operation 406). If the PE node has not received the packet via the multi-chassis trunk, the PE node checks whether the PE node has received the packet via a spoke (operation 408). If the local PE node is the active PE node (operation 404), or If the local PE node is not the active PE node and the PE node has not received the packet via a spoke (e.g., has received via a local edge port) (operations 404 and 408), the PE node forwards the packet to the remote PE node via the corresponding logical connection using the VC label associated with the logical connection (operation 412). In the example in FIG. 1C, PE node 112 forwards a packet to remote PE node 122 via corresponding logical connection 152 using VC label 182 of logical connection 152.

On the other hand, if the local PE node is not the active PE node (operation 404), and the PE node has received the packet via the multi-chassis trunk (operation 406) or a spoke (operation 408), the PE node forwards the packet to the remote PE node via the corresponding logical connection using the associated VC label of the active partner PE node's logical connection (operation 410). In the example in FIG. 1C, PE node 114 forwards a packet to remote PE node 122 via corresponding logical connection 164 using VC label 182 of logical connection 152 of PE node 112. In this way, an active or a standby PE node can use the VC label of an active PE node's logical connection and actively forward packet to a remote PE node. Forwarding the packet can include identifying an egress port associated with the egress logical connection of the packet and transmitting the packet via the identified egress port.

FIG. 4B presents a flowchart illustrating the process of a PE node in a multi-chassis trunk forwarding a multi-destination packet, in accordance with an embodiment of the present invention. A multi-destination packet is a packet which the PE node forwards via multiple ports. Examples of a multi-destination packet include, but are not limited to, an unknown unicast packet, a broadcast packet, or a multicast packet. Upon receiving a multi-destination packet (operation 452), the PE node checks whether the PE node has received the packet via a CE port (e.g., a local edge port or a port participating in the multi-chassis trunk) (operation 454). If the PE node has received the packet via a CE port, the PE node forwards the packet via other local edge ports (i.e., other than the port via which the PE node has received the packet) and via the spoke(s) (operation 456). In some embodiments, the PE node forwards the packet via a local edge port based on the virtual local area network (VLAN) settings of the port.

If the PE node has not received the packet via a CE port (operation 454) or has forwarded the packet via local edge port(s) and spoke(s) (operation 456), the PE node checks whether the local PE node is the active PE node (operation 458). If the PE node is not the active PE node (i.e., a standby PE node), the PE node forwards the packet via simulated active-active logical connection(s) using associated VC label of the active partner PE node's logical connection (operation 460). If the PE node is the active PE node, the PE node checks whether the PE node has received the packet via a logical connection (operation 462). If the PE node has received the packet via a logical connection, the PE node forwards the packet via other active-active logical connections using associated VC labels (operation 464).

If the PE node is the active node (operation 458) and has not received the packet via a logical connection (operation 462), the PE node forwards the packet via its active-active logical connections using associated VC labels (operation 466) and checks whether the PE node has received the packet via a spoke (operation 468). If the PE node has received the packet via a spoke, the PE node forwards the packet via the local edge port and any other spoke(s) (operation 470). In some embodiments, a PE node can be an active PE node for one multi-chassis trunk and a standby PE node for another. In some embodiments, the operations described in conjunction with FIGS. 4A and 4B are specific to a respective multi-chassis trunk.

### Failure Recovery

During operation, a PE node can be unavailable (e.g., can incur a link or a node failure). FIG. 5 illustrates exemplary unavailability in a virtual private network with a multi-chassis trunk, in accordance with an embodiment of the present invention. A virtual private network 500 includes network sites 510 and 530, interconnected via network 540. In some embodiments, network 540 is an MPLS network. Site 510 includes PE nodes 512 and 514. Multi-homed CE node 516 is coupled to partner PE nodes 512 and 514 via multi-chassis trunk 518. PE nodes 512 and 514 can be coupled to each other via one or more physical links. PE nodes 512 and 514 create a separate network 542 and interconnect each other via spoke 550. In some embodiments, spoke 550 is a MPLS-based VPLS pseudo-wire. Partner PE nodes 512 and 514 select PE node 512 as the active node and PE node 514 as a standby node. Site 530 includes CE node 534 coupled to node 532 via one or more physical links. PE node 512 establishes active-active logical connections 552 and PE node 514 establishes simulated active-active logical connection 554 with remote PE node 532, respectively.

Suppose that event 562 fails active PE node 512 and partner PE node 514 detects the failure. In some embodiments, partner PE nodes 512 and 514 exchange periodic control message via spoke 550 to notify each other regarding the respective operational states. If PE node 514 does not receive any control message from PE node 512 for a period of time, PE node 514 detects a failure to PE node 512. Upon detecting the failure of the active PE node 512, standby PE node 514 starts operating as the active PE node and forwards the traffic received from CE node 516 to remote PE node 532.

Suppose that event 564 fails spoke 550. Since PE nodes 512 and 514 both use the VC label of logical connection 552, when spoke 550 fails, the corresponding VPLS instance may still support multi-chassis trunk 518 as long as PE nodes 512 and 514 can communicate and synchronize with each other. Otherwise, in some embodiments, if the links coupling CE node 516 to PE nodes 512 and 514 remain active, PE nodes 512 and 514 initiate a master-slave selection process for the corresponding VPLS instance. In a master-slave mode of operation, the master node actively forwards traffic while the slave nodes remain inactive. If PE node 514 is selected as the master node, PE node 514 creates and sends a notification message to CE node 516 indicating its master status. PE node 512 becomes inactive. In some embodiments, PE node 512 can go to a sleep mode. As a result, only PE node 514 receives traffic from CE node 516 and forwards the traffic to remote PE node 532.

Suppose that event 566 fails the link between PE node 514 and CE node 516. Consequently, multi-chassis trunk 518 fails as well. PE nodes 512 and 514 both become active and start forwarding traffic from locally coupled CE nodes. In this example, PE node 512 forwards traffic from CE node 516. Suppose that event 568 fails active-active logical connection 552. Because logical connection 552 is an MPLS connection, an MPLS failure recovery process is triggered.

FIG. 6A presents a flowchart illustrating the process of a PE node in a multi-chassis trunk recovering from a partner node's unavailability, in accordance with an embodiment of the present invention. Upon detecting an unavailability of a partner PE node (operation 602), the PE node checks whether the unavailable PE node has been the active PE node (operation 604). In some embodiments, the PE node detects a failure by not receiving a control message for a predetermined period of time. If the failed node has been the active PE node, the PE node checks whether any other standby PE nodes are available (operation 606). A respective partner PE node can remain aware of all other operational PE nodes by exchanging control messages.

If other standby PE nodes are available, the PE node selects an active PE node in conjunction with other standby PE nodes (operation 608), as described in conjunction with FIG. 1A. The PE node then checks whether the local PE node is selected as the active PE node (operation 610). If no other standby PE node is available (operation 606) or the local PE node is selected as the active node (operation 610), the PE node starts operating as the active PE node (operation 612). If the local PE node is not selected as the active node, the PE node stores the new active PE node information (operation 614).

FIG. 6B presents a flowchart illustrating the process of a PE node in a multi-chassis trunk recovering from a link failure, in accordance with an embodiment of the present invention. Upon detecting the link failure (operation 652), the PE node checks whether the failure is a spoke failure (operation 654). If the failure is a spoke failure, the PE node checks whether the partner PE node associated with the spoke is still reachable (operation 656). If reachable, the PE node may still forward packet using the VC label of the logical connection of the active PE node in the multi-chassis trunk. If the partner PE node is not reachable, the PE node checks whether the links participating the multi-chassis trunk are operational (e.g., the links of the multi-chassis trunk coupling a CE node) (operation 664).

If the links in the multi-chassis trunk are operational, the PE node selects a master node in conjunction with other partner PE nodes (operation 666). In some embodiments, the partner PE nodes select the PE node with the lowest (or highest) identifier as the master node. The PE node then checks whether the local PE node is selected as the master node (operation 668). If the local node is selected as the master node, the PE node constructs and sends a message notifying the CE node associated with the multi-chassis trunk regarding the master status of the PE node (operation 670). Sending the message can include identifying an egress port for the message and transmitting the message via the identified egress port.

If a spoke has not failed, the PE node checks whether a link participating in the multi-chassis trunk has failed (operation 658). If not, the PE node initiates the MPLS failure recovery process (operation 680). If a link participating in the multi-chassis trunk has failed, the PE node terminates the spoke(s) with partner PE nodes (operation 660). If one or more links of the multi-chassis trunk are not operational (operation 664), the local PE node has constructed and sent a notification message to the CE node (operation 670), or the PE node has terminated the spoke(s) (operation 660), the PE node starts operating as the active PE node for the corresponding VPLS instance (operation 668). Note that an active PE node forwards traffic via its logical connections. The PE node then constructs and sends messages notifying the remote PE nodes regarding the active status of the PE node (operation 670).

### Exemplary Switch System

FIG. 7 illustrates an exemplary architecture of a switch operating as a PE node, in accordance with an embodiment of the present invention. In this example, a switch 700 includes a number of communication ports 702, a packet processor 710, a logical connection module 730, and a storage device 750. In some embodiments, logical connection module 730 further includes a trunk module 732. Storage device 750 stores a link aggregation database 740. Trunk module 730 enables switch 700 to join a multi-chassis trunk in conjunction with other switches. At least one of the communication ports 702 participate in the multi-chassis trunk. Packet processor 710 extracts and processes header information from the received packets via communication ports 702.

In some embodiments, switch 700 may maintain a membership in a fabric switch, wherein switch 700 also includes a fabric switch management module 760. Fabric switch management module 760 maintains a configuration database in storage device 750 that maintains the configuration state of every switch within the fabric switch. Fabric switch management module 760 maintains the state of the fabric switch, which is used to join other switches. In some embodiments, switch 700 can be configured to operate in conjunction with a remote switch as a logical Ethernet switch. Under such a scenario, communication ports 702 can include inter-switch communication channels for communication within a fabric switch. This inter-switch communication channel can be implemented via a regular communication port and based on any open or proprietary format. Communication ports 702 can include one or more TRILL interfaces capable of receiving packets encapsulated in a TRILL header. Packet processor 710 can process these packets.

Link aggregation database 740 stores configuration information regarding a plurality of switches participating in a multi-chassis trunk. This plurality of switches includes switch 700 and a second switch. Logical connection module 730 constructs a packet for a remote switch. This packet is forwardable via a logical connection. The packet includes a virtual circuit label associated with a second logical connection of the second switch, as described in conjunction with FIG. 1C. In some embodiments, switch 700 is a standby switch and the second switch is an active switch of the multi-chassis trunk. Logical connection module 730 can extract the virtual circuit label from the payload of a notification message. Trunk module 732 selects switch 700 as an active switch in response to an unavailability of the second switch. In some embodiments, logical connection module 730 also constructs a packet for a second remote switch, as described in conjunction with FIG. 2. This packet is forwardable via a second logical connection between switch 700 and the second remote switch.

Note that the above-mentioned modules can be implemented in hardware as well as in software. In one embodiment, these modules can be embodied in computer-executable instructions stored in a memory which is coupled to one or more processors in switch 700. When executed, these instructions cause the processor(s) to perform the aforementioned functions.

In summary, embodiments of the present invention provide a switch and a method for load balancing of logical connections over a multi-chassis trunk. In one embodiment, the switch includes a link aggregation database and a packet processor. The link aggregation database stores configuration information regarding a plurality of switches participating in a multi-chassis trunk. The plurality of switches includes the switch. The packet processor constructs a packet for a remote switch. This packet is forwardable via a logical connection. The packet includes a virtual circuit label associated with a second logical connection of a second switch. The plurality of switches includes the second switch as well.

The methods and processes described herein can be embodied as code and/or data, which can be stored in a computer-readable non-transitory storage medium. When a computer system reads and executes the code and/or data stored on the computer-readable non-transitory storage medium, the computer system performs the methods and processes embodied as data structures and code and stored within the medium.

The methods and processes described herein can be executed by and/or included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of embodiments of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A switch, comprising:
a link aggregation database adapted to store information regarding a plurality of switches participating in a multi-chassis trunk, wherein the plurality of switches include the switch; and
a logical connection module adapted to construct a packet for a remote switch, wherein the packet is forwardable via a logical connection,
wherein the packet includes a virtual circuit label associated with a second logical connection of a second switch, wherein the plurality of switches include the second switch.

2. The switch of claim 1, wherein a respective logical connection is a pseudo-wire associated with a virtual private local area network (LAN) service (VPLS) instance, wherein the pseudo-wire represents a logical link in a virtual private network (VPN).

3. The switch of claim 2, wherein the pseudo-wire is based on one or more of:
Internet Protocol (IP); and
Multiprotocol Label Switching (MPLS) connection.

4. The switch of claim 1, wherein the switch is a standby switch and the second switch is an active switch of the multi-chassis trunk.

5. The switch of claim 4, further comprising a trunk module adapted to select the switch as an active switch in response to an unavailability of the second switch.

6. The switch of claim 1, the logical connection module is further adapted to extract the virtual circuit label from the payload of a notification message.

7. The switch of claim 1, wherein logical connection module is further adapted to construct a packet for a second remote switch, wherein the packet is forwardable via a second logical connection between the switch and the second remote switch, and wherein the remote switch and the second remote switch participate in a second multi-chassis trunk.

8. The switch of claim 7, wherein the second logical connection is a virtual leased line (VLL).

9. A computer-executable method, comprising:
storing configuration information regarding a plurality of switches participating in a multi-chassis trunk, wherein the plurality of switches include a switch; and
constructing a packet for a remote switch, wherein the packet is forwardable via a logical connection,
wherein the packet includes a virtual circuit label associated with a second logical connection of a second switch, wherein the plurality of switches include the second switch.

10. The method of claim 9, wherein a respective logical connection is a pseudo-wire associated with a virtual private local area network (LAN) service (VPLS) instance, wherein the pseudo-wire represents a logical link in a virtual private network (VPN).

11. The method of claim 10, wherein the pseudo-wire is based on one or more of:
Internet Protocol (IP); and
Multiprotocol Label Switching (MPLS) connection.

12. The method of claim 9, wherein the switch is a standby switch and the second switch is an active switch of the multi-chassis trunk.

13. The method of claim 12, further comprising selecting the switch as an active switch in response to an unavailability of the second switch.

14. The method of claim 9, further comprising extracting the virtual circuit label from the payload of a notification message.

15. The method of claim 9, further comprising constructing a packet for a second remote switch, wherein the packet is forwardable via a second logical connection between the switch and the second remote switch, and wherein the remote switch and the second remote switch participate in a second multi-chassis trunk.

16. The method of claim 15, wherein the second logical connection is a virtual leased line (VLL).

17. A system, comprising:
a processor;
a memory storing instructions that when executed by the processor cause the system to perform a method, the method comprising:
storing configuration information regarding a plurality of switches participating in a multi-chassis trunk, wherein the plurality of switches include a switch; and
constructing a packet for a remote switch, wherein the packet is forwardable via a logical connection,
wherein the packet includes a virtual circuit label associated with a second logical connection of a second switch, wherein the plurality of switches include the second switch.

18. The system of claim 17, wherein a respective logical connection is a pseudo-wire associated with a virtual private local area network (LAN) service (VPLS) instance, wherein the pseudo-wire represents a logical link in a virtual private network (VPN).

19. The system of claim 18, wherein the pseudo-wire is based on one or more of:
Internet Protocol (IP); and
Multiprotocol Label Switching (MPLS) connection.

20. The system of claim 17, wherein the switch is a standby switch and the second switch is an active switch of the multi-chassis trunk.

21. The system of claim 20, wherein the method further comprises selecting the switch as an active switch in response to an unavailability of the second switch.

22. The system of claim 17, wherein the method further comprises extracting the virtual circuit label from the payload of a notification message.

23. The method of claim 23, further comprising constructing a packet for a second remote switch, wherein the packet is forwardable via a second logical connection between the switch and the second remote switch, and wherein the remote switch and the second remote switch participate in a second multi-chassis trunk.

24. The method of claim 24, wherein the second logical connection is a virtual leased line (VLL).
